(19) United States
(12) Patent Application Publication
(10) Pub. No.: US 2019/0130688 A1
(43) Pub. Date: May 2, 2019

(54) APPARATUS, MANAGEMENT SYSTEM, AND NON-TRANSITORY COMPUTER READABLE MEDIUM

(71) Applicant: FUJI XEROX CO., LTD., Tokyo (JP)

(72) Inventor: Kengo TOKUCHI, Kanagawa (JP)

(73) Assignee: FUJI XEROX CO., LTD., Tokyo (JP)

(21) Appl. No.: 16/114,256

(22) Filed: Aug. 28, 2018

(30) Foreign Application Priority Data
Oct. 26, 2017 (JP) 2017-207334

(51) Int. Cl. G07C 9/00; G08B 21/18; G06Q 30/06

(52) U.S. Cl. CPC G07C 9/00896; G07C 9/00309; G07C 2009/00769; G06Q 30/0645; G07C 2009/00428; G08B 21/18

(57) ABSTRACT

An apparatus includes a controller. When an operation to set a door in a state in which the door will be opened is performed by a first existing subject and if a second existing subject is located on a path on which the door moves to open, the controller causes an informing unit to provide information that the door will be opened and the second existing subject is on the path.

### CROSS-REFERENCE TO RELATED APPLICATIONS

This application is based on and claims priority under 35 USC 119 from Japanese Patent Application No. 2017-207334 filed Oct. 26, 2017.

### BACKGROUND

### (i) Technical Field

The present invention relates to an apparatus, a management system, and a non-transitory computer readable medium.

### (ii) Related Art

Doors are divided into various types according to the structure and how it is opened and closed.

### SUMMARY

According to an aspect of the invention, there is provided an apparatus including a controller. When an operation to set a door in a state in which the door will be opened is performed by a first existing subject and if a second existing subject is located on a path on which the door moves to open, the controller causes an informing unit to provide information that the door will be opened and the second existing subject is on the path.

### BRIEF DESCRIPTION OF THE DRAWINGS

Exemplary embodiments of the present invention will be described in detail based on the following figures, wherein:

FIG. 1 schematically illustrates an example of the overall configuration of a management system;

FIG. 2 is an external view of an example of the configuration of a space to be rented to a user;

FIG. 3 is a block diagram illustrating an example of the hardware configuration of a user terminal;

FIG. 4 is a block diagram illustrating an example of the hardware configuration of a server forming the management system;

FIG. 5 is a block diagram illustrating an example of the configuration of a space which forms the management system;

FIG. 6 is a block diagram illustrating an example of the software configuration of a control device;

FIG. 7 is a flowchart illustrating an example of a control operation executed by a controller according to a first example;

FIGS. 8A and 8B illustrate an example of a control operation when someone opens an outward-opening-type door from indoors;

FIGS. 9A and 9B illustrate another example of a control operation when someone opens an outward-opening-type door from indoors;

FIGS. 10A and 10B illustrate an example of a control operation when someone opens an inward-opening-type door from outdoors;

FIGS. 11A and 11B illustrate an example of a control operation when someone opens an inward-opening-type door from indoors;

FIGS. 12A and 12B illustrate an example of a control operation when someone opens a sliding door;

FIG. 13 is a flowchart illustrating an example of a control operation executed by the controller according to a second example;

FIG. 14 is a flowchart illustrating an example of a control operation executed by the controller according to a third example;

FIG. 15 is a flowchart illustrating an example of a control operation executed by the controller according to a fourth example;

FIG. 16 is a flowchart illustrating an example of a control operation executed by the controller according to a fifth example;

FIG. 17 illustrates a specific example of a control operation in the fifth example;

FIG. 18 is a flowchart illustrating an example of a control operation executed by the controller according to a sixth example;

FIG. 19 illustrates an example in which an outward-opening-type door is fixed to a space and a door moving range is indicated by illumination light;

FIG. 20 illustrates an example in which an inward-opening-type door is fixed to a space and plural light sources are disposed along the outer edge of a door moving range;

FIG. 21 illustrates an example of a mechanism for decreasing the speed of a hinged door that has started to open;

FIG. 22 is a flowchart illustrating an example of a speed control operation to be performed when a hinged door is opened; and

FIG. 23 schematically illustrates another example of the configuration of a management system.

### DETAILED DESCRIPTION

Exemplary embodiments of the invention will be described below with reference to the accompanying drawings.

### EXEMPLARY EMBODIMENT

### [Overall Configuration of Management System]

Due to the increased communication speed and smaller communication terminals, users can now access various items of information even outside the office. On the other hand, however, business conversations and information are highly confidential, and quiet and high-security environments are desirably provided.

In this exemplary embodiment, a management system for providing spaces that satisfy such a demand will be described. Spaces, which will be described below, are not restricted for business use, but may also be for personal use.

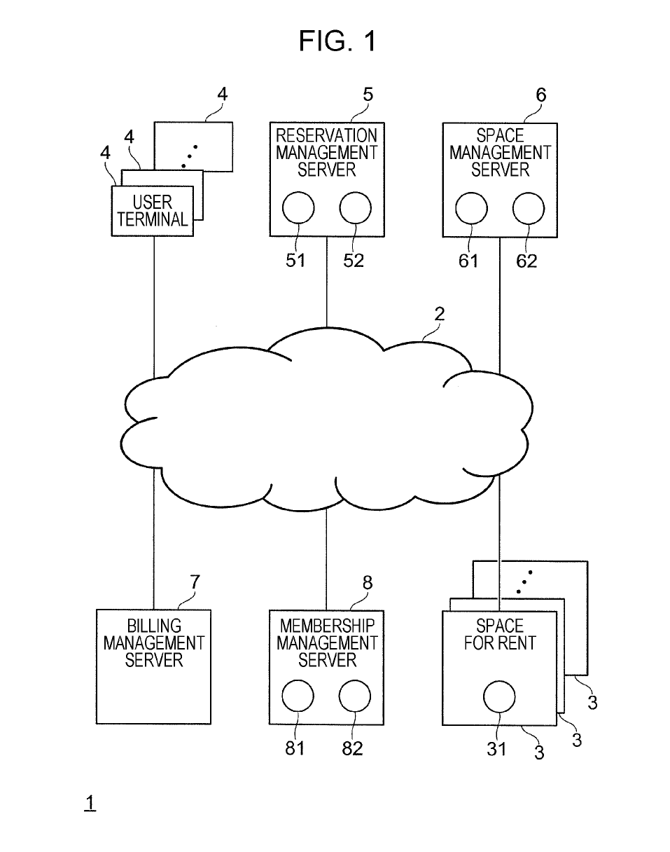

FIG. 1 schematically illustrates an example of the overall configuration of a management system 1.

As shown in FIG. 1, the management system 1 is constituted by various terminals connected to a cloud network 2.

In the example in FIG. 1, the management system 1 includes multiple spaces 3 for rent, multiple user terminals 4, a reservation management server 5, a space management server 6, a billing management server 7, and a membership management server 8. The spaces 3 for rent are spaces to be rented on a time basis. Hereinafter, the spaces 3 for rent may simply be called the spaces 3. The user terminals 4 are carried by individual users using the spaces 3. The reservation management server 5 manages reservations for the spaces 3. The space management server 6 manages the usage statuses of the individual spaces 3. The billing management server 7 bills users for the use of the spaces 3. The membership management server 8 manages information concerning members entitled to use the spaces 3.

The spaces 3 are available twenty-four hours a day, seven days a week (24/7), except for the time reserved for maintenance, for example.

In the management system 1 shown in FIG. 1, one server is provided for one purpose (function). Alternatively, plural servers may be provided for one purpose (function). Conversely, one server may be provided for multiple purposes (functions).

Renting services for the spaces 3 may be provided by one business operator or plural business operators. For example, different business operators may separately conduct management concerning reservations, access to and usage statuses of the spaces 3, billing for the use of the spaces 3, and members registered as users. Alternatively, multiple business operators may conduct management concerning one purpose (function) collaboratively.

Plural servers may be provided for one purpose (function). If a single business operator provides plural servers for one purpose (function) or provides plural servers for multiple purposes (functions), the plural servers are connected to each other via an intranet.

The spaces 3 may be provided by a single business operator or plural business operators.

The management system 1 may be implemented as an aggregation of services provided by plural business operators.

In this exemplary embodiment, a digital key is used for locking and unlocking a space 3. A digital key is stored in a user terminal 4 or an integrated circuit (IC) card which supports near field communication (NFC) (not shown). If a user terminal 4 is used as a digital key, a digital key is provided from the reservation management server 5 to the user terminal 4 after a reservation is confirmed. If an IC card is used as a digital key, an IC card having a digital key recorded thereon is distributed from the reservation management server 5 to a user terminal 4 after a reservation is confirmed.

The use of a digital key makes it possible to freely determine an effective time period for which a space 3 can be locked and unlocked. Multiple digital keys for using one space 3 for the same time period may be issued.

Alternatively, multiple physical keys may be provided according to the reserved time to lock and unlock a space 3. User authentication may alternatively be conducted instead of the use of a key or as a function for supporting the use of a digital key or a physical key.

The reservation management server 5 manages a registration list 51 and a reservation list 52. In the registration list 51, vacancies for spaces 3 are registered. The reservation management server 5 manages the allocation of reservation holders to the spaces 3 by using the reservation list 52.

In this exemplary embodiment, the reservation management server 5 receives reservation requests for the spaces 3 24/7, except for the time reserved for maintenance, for example. The reservation management server 5 also issues digital keys to the user terminals 4 and conducts authentication if necessary. The space management server 6 may alternatively conduct authentication.

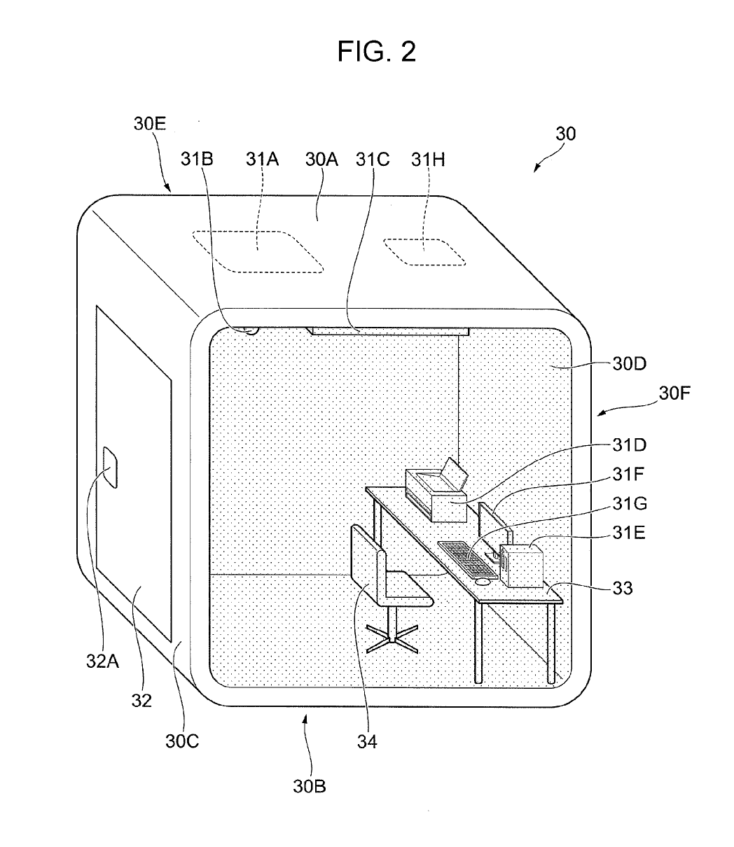

The space management server 6 manages information 61 concerning access to the individual spaces 3 and information 62 concerning the usage statuses of the individual spaces 3. The space management server 6 also serves the function of communicating with an authentication unit 32A (see FIG. 2) disposed in a space 3 to decide whether to permit a user to enter this space 3. When conducting authentication, the space management server 6 communicates with the reservation management server 5.

The space management server 6 also serves the function of collecting information from various devices 31 disposed in a space 3 and controlling the various devices 31.

The space management server 6 is connected to the cloud network 2 in FIG. 1. However, some or all of the functions of the space management server 6 may be integrated in a space 3.

The billing management server 7 serves the function of billing an individual member (may be a natural person (individual) or a legal person (enterprise)) based on reservation information, user information, information concerning access to a space 3. The billing management server 7 obtains reservation information from the reservation management server 5, information concerning access to a space 3 from the space management server 6, and membership information from the membership management server 8.

The membership management server 8 manages information concerning registered members and information concerning users. If a member is an individual person, the member is a user using a space 3. If a member is an enterprise, individual users are registered and managed according to the member.

FIG. 2 is an external view of an example of the configuration of a space 3 to be rented to a user.

In this exemplary embodiment, the spaces 3 are disposed indoors and outdoors, such as in station buildings, airports, office buildings, commercial complexes, for example, restaurants and department stores, banks, libraries, art galleries, museums, public institutions and facilities, passageways, and parks.

In this exemplary embodiment, a soundproof, small room is assumed as a space 3. In this sense, the space 3 is an example of a closed space. In this exemplary embodiment, however, “closed” does not mean “sealed”, but is used in the sense of a space having a practical soundproof function. Openings and gaps, such as vent holes and small windows, may be provided in part of a skeleton 30 forming a space 3.

The skeleton 30 includes a ceiling 30A, a floor 30B, a wall 30C to which a door 32 is fixed, two walls 30D and 30E at both sides of the wall 30C, and a wall 30F opposite the door 32.

In this exemplary embodiment, a single hinged door is assumed as the door 32. In the single hinged door, a single door member is opened and closed such that it draws an arc. However, the door 32 may be a double hinged door having two door members.

The door 32 may be a sliding door. The sliding door may be a single sliding door in which one door member slides, a multiple sliding door set in which two or more door members slide in opposite directions on different rails, or a separate double sliding door set in which one door member slides to the left and the other door member slides to the right.

The door 32 may be a folding door in which a pair of door members connected by a hinge opens to fold back. The folding door has a single type which opens to one side and a double type which opens to two sides.

The door 32 may be a special door, such as a partition door or a pocket door which is withdrawn into a wall when it is not used.

The door 32 may be an inward opening type or an outward-opening type.

In this exemplary embodiment, the walls 30D and 30E are partly constituted by a light-transmitting member, such as glass and acrylic resin, for example.

The structure, material, or processing to implement a blind function may be utilized for at least part of the walls 30D and 30E. The blind function makes it difficult to see the inside of the space 3 from the outside or to reduce the visibility through the walls 30D and 30E.

The material of the walls 300 and 30E may be a translucent member or a member with small scratches on its surface so as to cause light to scatter. A film-like member having a similar function may be attached to the walls 30D and 30E. The film-like member may be a liquid crystal film that can electrically switch between a transparent state and an opaque state or a polarizing film that can electrically control the luminous transmittance.

A structure or a member for a blind function may be provided separately. The walls 30D and 30E, as well as the other surfaces, may be made of a member that does not transmit light. Conversely, among the elements forming the skeleton 30, three or more surfaces may be made of a transparent or translucent member.

The number of users using a space 3 is largely determined by the volume of this space 3. Basically, in this exemplary embodiment, a private room for one person is assumed as a space 3. However, the space 3 may be a large room for accommodating a large group of people. A large room may be formed as one room, or it may be formed by interconnecting spaces 3 by removing one of or both of the walls 30D and 30E of each space 3.

A private room is not necessarily for only one person, and may be used for a few people, such as two or three people.

The configuration and structure of the skeleton 30 forming an individual space 3, and facilities to be provided by the space 3 and their performance may be determined as desired.

In this exemplary embodiment, one desk 33 and one chair 34 are disposed within the skeleton 30. On the desk 33, a printer 31D, a computer 31E, a display device 31F, and an input device 31G, which are examples of the devices 31, are placed. To protect user information, data and history information stored in the computer 31E are all deleted under the control of the system after the use of the space 3.

As the other devices 31, an air conditioner 31A, a human sensor 31B, a lighting fixture 31C used as indoor illumination, a control device 31H, and an authentication unit 32A are fixed. The control device 31H controls the operation of electronic devices including the devices 31.

The devices 31 are only examples of electronic devices. The printer 31D, the computer 31E, the display device 31F, and the input device 31G on the desk 33 may not necessarily be provided. In this case, a user uses its own computer or smartphone.

The entirety of the space 3 (including the skeleton 30) or the control device 31H is an example of an apparatus. The control device 31H is also an example of a controller.

Each of the user terminal 4, the reservation management server 5, the space management server 6, the billing management server 7, and the membership management server 8 is also an example of the apparatus.

The management system 1 is an example of a management system.

### [Configuration of Terminal]

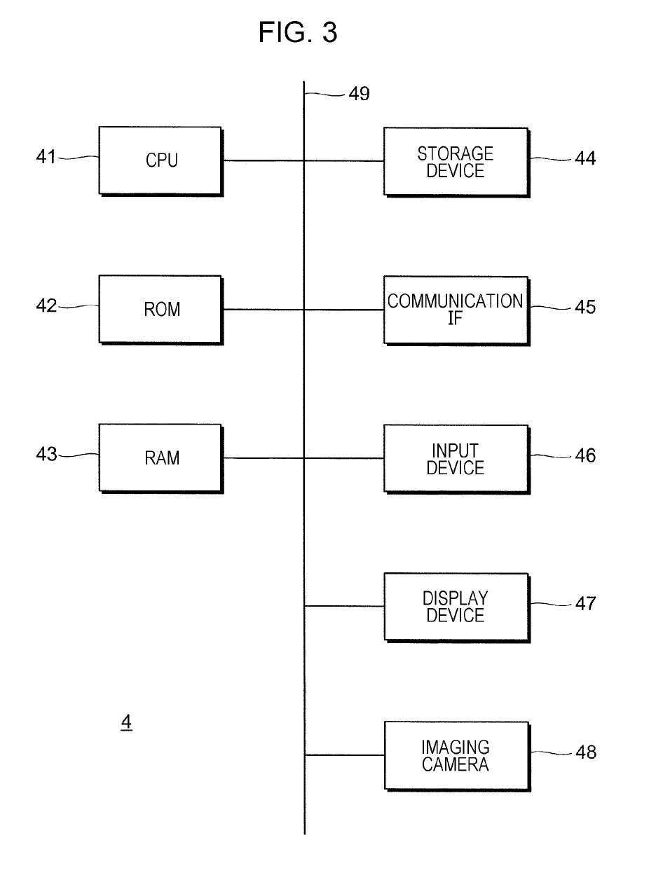

Examples of the configurations of the terminals forming the management system 1 will be discussed below with reference to FIGS. 3 through 5.

FIG. 3 is a block diagram illustrating an example of the hardware configuration of the user terminal 4.

In this exemplary embodiment, a smartphone is used as the user terminal 4.

The user terminal 4 includes a central processing unit (CPU) 41, a read only memory (ROM) 42, and a random access memory (RAM) 43. The CPU 41 provides various functions by executing firmware and application programs. The ROM 42 is a storage area in which firmware and basic input output system (BIOS) are stored. The RAM 43 is an area where a program is executed.

The user terminal 4 also includes a volatile storage device 44, a communication interface 45 (communication IF), an input device 46, such as a touchscreen, a display device 47, and an imaging camera 48. The storage device 44, which is a semiconductor memory, for example, stores downloaded application programs and a digital key, for example. The communication IF 45 is used for communicating with external devices. The display device 47 is used for displaying information.

The CPU 41 is connected to the devices forming the user terminal 4 via a bus 49.

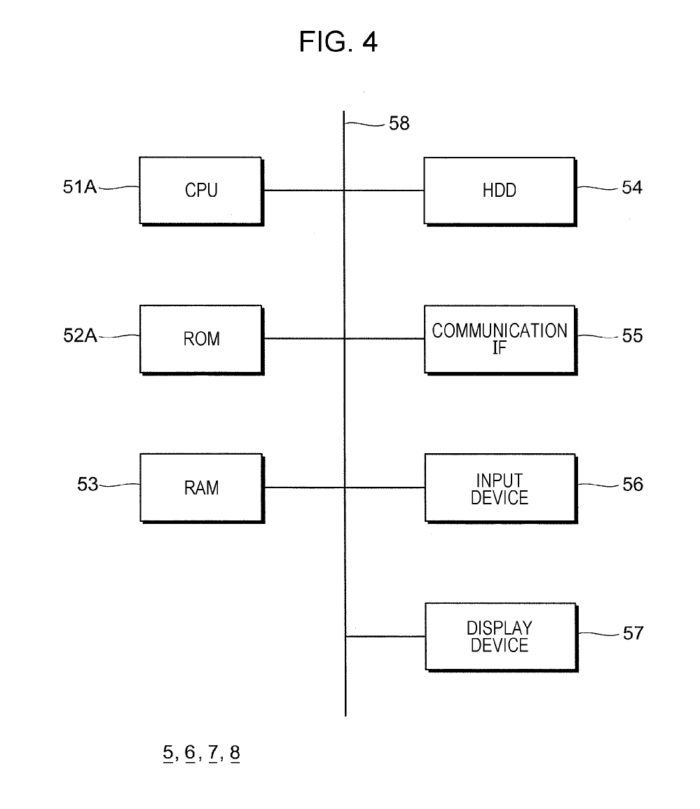

FIG. 4 is a block diagram illustrating an example of the hardware configuration of a server forming the management system 1.

The configuration of the reservation management server 5 is shown in FIG. 4 as a typical example of the server. The configurations of the other servers, that is, the space management server 6, the billing management server 7, and the membership management server 8, are similar to the configuration of the reservation management server 5.

The reservation management server 5 includes a CPU 51A, a ROM 52A, and a RAM 53. The CPU 51A provides various management functions by executing an operating system (OS) and application programs. The ROM 52A is a storage area in which an OS and a BIOS are stored. The RAM 53 is an area where a program is executed.

The reservation management server 5 also includes a volatile hard disk drive (HDD) 54, a communication IF 55, an input device 56, such as a keyboard, and a display device 57. The HDD 54 stores application programs and various items of management data for implementing the associated management functions. The communication IF 55 is used for communicating with external devices. The display device 57 is used for displaying information.

The CPU 51A is connected to the devices via a bus 58.

Each server is an example of a database for storing management data.

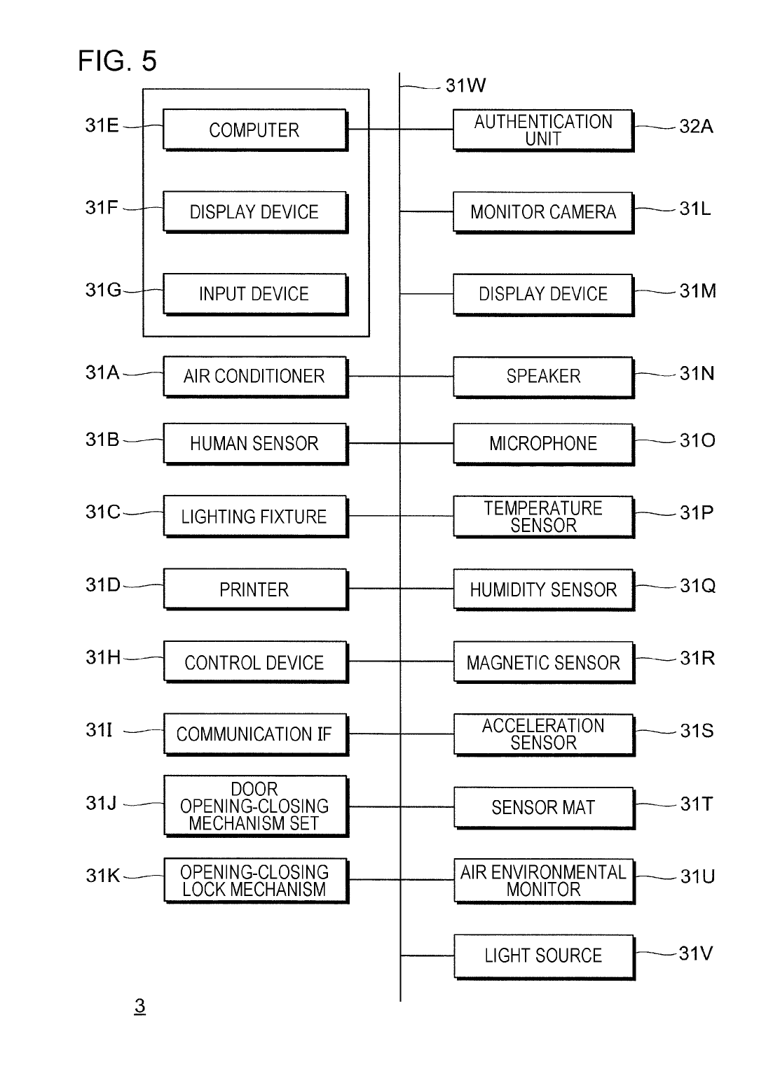

FIG. 5 is a block diagram illustrating an example of the configuration of a space 3 which forms the management system 1.

The space 3 includes an air conditioner 31A, a human sensor 31B, a lighting fixture 31C, a printer 31D, a computer 31E, a display device 31F, an input device 31G, a control device 31H, and an authentication unit 32A.

The air conditioner 31A is used for adjusting the temperature and humidity within the space 3 (room). A mechanism specially used for ventilation may be provided, together with or separately from the air conditioner 31A.

The human sensor 31B is a sensor for detecting people within the space 3. As the human sensor 31B, various types of sensors, such as a pyroelectric infrared human sensor that can detect the motion of people, and an image human sensor and a thermopile human sensor that can detect the number and position of people, are available. One or plural of these types of sensors are used according to the purpose of use.

The printer 31D, the computer 31E, the display device 31F, and the input device 31G are examples of information devices installed in the room for a user to operate. These information devices are connected to each other via a local area network (LAN) 31W, such as a LAN cable or a wireless LAN. If a user brings its own computer, the computer is connected to the LAN 31W. As the wireless LAN, WiFi (registered trademark) or Bluetooth (registered trademark) is used.

The control device 31H is a control computer that collects information from the devices 31 connected to the LAN 31W and also controls the operations of the individual devices 31. In some management systems 1, the control device 31H provides the functions of the space management server 6.

The authentication unit 32A is fixed to the door 32 of the space 3, for example. The authentication unit 32A is used for obtaining and sending and receiving information required for locking and unlocking the door 32. Authentication is conducted in the reservation management server 5, and an authentication result is only supplied to the authentication unit 32A. When authentication has succeeded, the authentication unit 32A unlocks the door 32. After unlocking the door 32, a user can open and close the door 32 to enter the space 3 (see FIG. 2).

The space 3 also includes a communication IF 31I for communicating with external devices. The communication IF 31I is connected to the cloud network 2 (see FIG. 1) to communicate with various servers.

The space 3 also includes a door opening-closing mechanism set 31J for mechanically controlling the opening and closing of the door 32. The door opening-closing mechanism set 31J includes a mechanism for driving the door 32 to open and close and a mechanism for adjusting the magnitude of a load required for a user to open and close the door 32.

The space 3 also includes an opening-closing lock mechanism 31K. The opening-closing lock mechanism 31K temporarily stops the opening and closing of the door 32. While the opening-closing lock mechanism 31K is in operation, at least the operation of closing the door 32 is temporarily stopped.

The space 3 also includes a monitor camera 31L for monitoring the motion of users indoors and outdoors. However, the monitor camera 31L may not necessarily be provided.

The space 3 also includes a display device 31M. In this exemplary embodiment, the display device 31M is disposed on the external side of the wall 30C to which the door 32 is fixed, and is used for a user to operate when entering the space 3 and also for providing information. The display device 31M is also used for a user using the space 3 and also for providing information.

The space 3 also includes a speaker 31N. The speaker 31N is used for supplying information to a user indoors and to people outdoors. The speaker 31N is an example of an informing unit.

The space 3 also includes a microphone 31O. The microphone 31O is used for collecting indoor sound.

The space 3 also includes a temperature sensor 31P. The temperature sensor 31P is used for measuring the indoor temperature.

The space 3 also includes a humidity sensor 31Q. The humidity sensor 31Q is used for measuring the indoor humidity.

The space 3 also includes a magnetic sensor 31R. The magnetic sensor 31R is attached to the door 32 to detect the opening or closing of the door 32 by sensing a magnetic force.

The space 3 also includes an acceleration sensor 31S. The acceleration sensor 31S is used for detecting the motion of an object.

The space 3 also includes a sensor mat 31T. The sensor mat 31T detects the weight of an object to visualize the time period for which a user has stayed in the space 3 or the congestion status of the space 3.

The space 3 also includes an air environmental monitor 31U. The air environmental monitor 31U, which detects constituents contained in air in the space 3, measures concentrations of PM2.5 and PM10, carbon dioxide, and volatile organic compounds. The air environmental monitor 31U may also measure the temperature and the humidity. The air environmental monitor 31U may not necessarily measure all of the above-described constituents or may measure other constituents. If the air environmental monitor 31U measures the temperature and the humidity, the provision of the temperature sensor 31P and the humidity sensor 31Q may be omitted.

The space 3 also includes a light source 31V. The light source 31V indicates the moving range of the door 32 (see FIG. 2) or the outer edge of the moving range by light irradiation or illumination. If the moving range of the door 32 is indicated by illumination light, one or plural spotlights are used. If the outer edge of the moving range of the door 32 is indicated, multiple light emitting devices (LEDs) embedded in the floor 30B along the outer edge are used. This type of light source 31V is not necessarily integrated with the space 3, but may be disposed in a place where the space 3 is disposed.

### [Control Function]

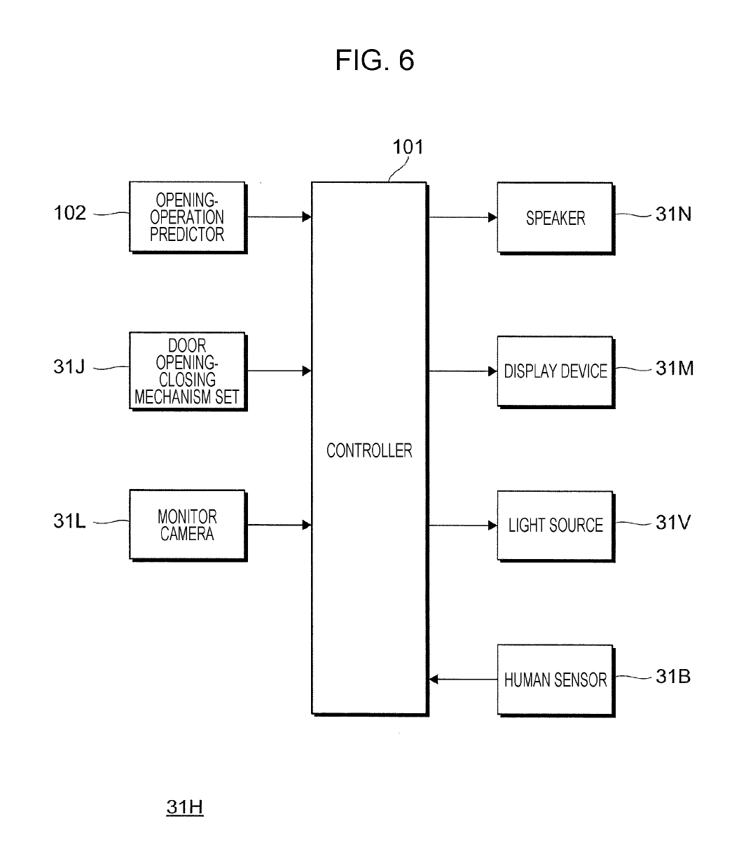

A control function implemented by one of the terminals forming the management system 1 (see FIG. 1) or by collaborative work of some of the terminals will be discussed below with reference to FIG. 6.

A description will be given of a case in which the control function is implemented by the control device 31H alone.

FIG. 6 is a block diagram illustrating an example of the software configuration of the control device 31H.

The control device 31H implements the corresponding functions by executing a program.

The control device 31H includes a controller 101 and an opening-operation predictor 102. The controller 101 provides information that the door 32 (see FIG. 2) will open and that someone is near the door 32. The opening-operation predictor 102 predicts that the door 32 will open. The controller 101 also has the function of indicating a moving range of the door 32 and also controlling the opening speed of the door 32. The controller 101 is an example of a controller.

The opening-operation predictor 102 predicts that the door 32 will open by analyzing imaging data output from the monitor camera 31L, for example. If someone is located within a range detectable by the human sensor 31B, the opening-operation predictor 102 may determine that the door 32 will open. The range detectable by the human sensor 31B may be different between the inside of a space 3 and the outside of the space 3. The human sensor 31B and the monitor camera 31L are desirably installed inside a space 3 and outside the space 3.

In FIG. 6, the speaker 31N and the display device 31M are used for providing information to a person indoors and that outdoors. Each of the speaker 31N and the display device 31M is an example of an informing unit.

The door opening-closing mechanism set 31J is used for adjusting the opening speed of the door 32.

The light source 31V is used for indicating the moving range of the door 32 or its outer edge.

Specific examples of the control operation to be executed by using the door opening-closing mechanism set 31J and the light source 31V will be discussed later.

### Examples of Control Operation

Examples of the control operation implemented under the control of the controller 101 (see FIG. 6) will be described below.

### First Example

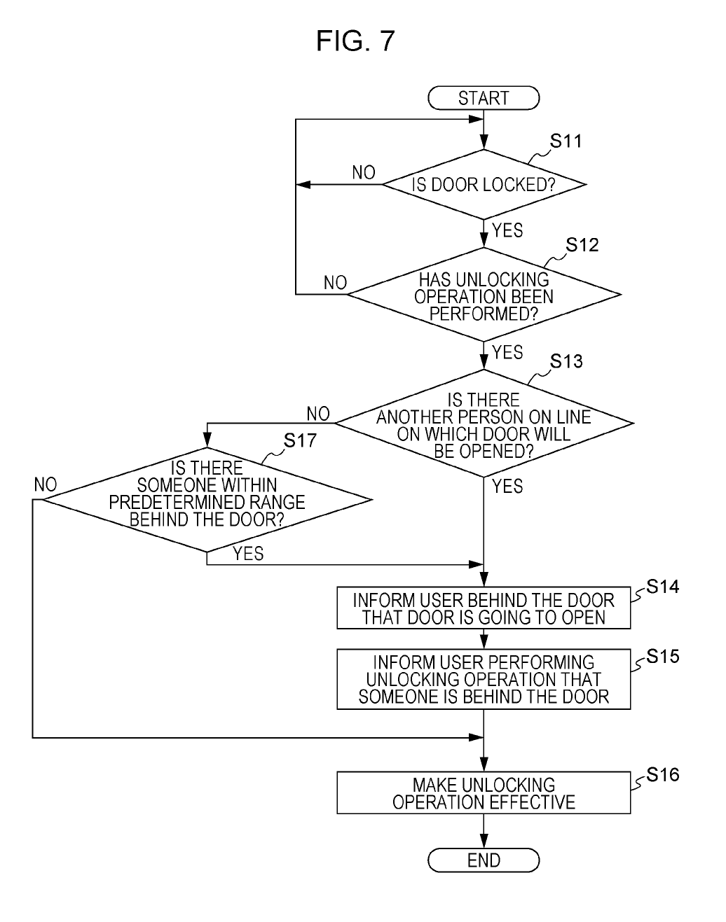

A first example of the control operation executed by the controller 101 will be discussed below with reference to FIGS. 7 through 11B.

FIG. 7 is a flowchart illustrating an example of the control operation executed by the controller 101 according to the first example.

The controller 101 judges in step S11 whether the door 32 is locked. The controller 101 executes step S11 regardless of whether a user is indoors. There may be a case in which the user leaves the space 3 for eating or going to the bathroom during a reserved time period.

While the result of step S11 is NO, the controller 101 repeats step S11.

If the result of step S11 is YES, the controller 101 judges in step S12 whether an unlocking operation has been performed.

The controller 101 executes step S12 regardless of whether a user is indoors. The unlocking operation may be performed either from inside a space 3 or outside the space 3.

The unlocking operation is an example of an operation to set a door in a state in which the door will be opened. The unlocking operation may include a certain action suggesting that the unlocking operation will be performed, such as a gesture of taking out a key or placing the user terminal 4 in front of the authentication unit 32A. The opening-operation predictor 102 is used to judge whether the unlocking operation has been performed.

If the result of step S12 is NO, the controller 101 returns to step S11.

If the result of step S12 is YES, the controller 101 judges in step S13 whether another person is located on a line on which the door 32 moves to open. In this case, the controller 101 makes this judgement for the entire surface of the door 32 as a plane. In other words, the controller 101 judges whether part of the body of a user or an object carried by this user is included within a three-dimensional space represented by the moving range of the door 32.

The controller 101 may alternatively make this judgement only for a range in which part of the surface of the door 32 (corresponding to a range of the body height, for example) moves. To put it more simply, the controller 101 may make this judgement only for a moving range of the door 32 corresponding to the area of the floor. To identify the position of a person, the human sensor 31V or the monitor camera 31L, for example, is used.

If the result of step S13 is YES, the process proceeds to step S14. In step S14, the controller 101 informs the person behind the door 32 that the door 32 is going to open by using the display device 31M (see FIG. 6) or the speaker 31N (see FIG. 6).

Then, in step S15, the controller 101 informs the user performing the unlocking operation that someone is behind the door 32 by using the display device 31M or the speaker 31N.

In the example in FIG. 7, the controller 101 provides the above-described information to a person behind the door 32 first and then provides the information to the person performing the unlocking operation. However, the order may be reversed. The controller 101 may alternatively provide the information to people on both sides at the same time. At this stage, the door 32 is still locked.

Then, in step S16, the controller 101 makes the unlocking operation effective. Thereafter, the door 32 can be opened. In this manner, the unlocking operation is made effective after the controller 101 has provided the information. A certain time can thus be secured after the information has been provided and before the door 32 is opened. The door 32 can be opened either from indoors or from outdoors.

If the result of step S13 is NO, the controller 101 judges in step S17 whether there is someone within a predetermined range behind the door 32. This judgement is made under the following situation, for example. If someone unlocks an inward-opening-type door 32 from indoors, it is checked whether there is someone within a predetermined range (range in which this person can reach the door 32, for example) behind the door 32. If someone leans against the door 32 on the other side, it may lose its balance if the door 32 is flung open inward. To identify the position of a person, the human sensor 31B or the monitor camera 31L, for example, is used.

If the result of step S17 is YES, the controller 101 proceeds to step S14 and provides the above-described information. If the result of step S17 is NO, the controller 101 proceeds to step S16. In this case, the user can open the door 32 without having to pay attention to anyone. The user can unlock the door 32 immediately.

### Specific Example 1

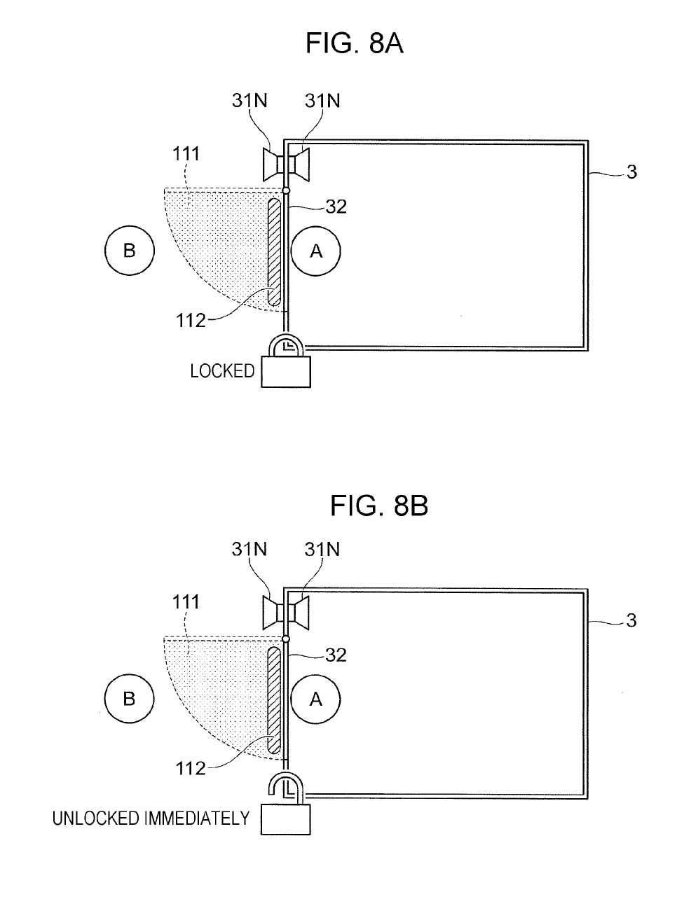

FIGS. 8A and 8B illustrate an example of the control operation when someone opens an outward-opening-type door 32 from indoors. FIG. 8A shows a state in which user B is located outside a range 111 in which the door 32 moves to open. FIG. 8B shows the control operation.

In the example in FIGS. 8A and 8B, user B is located, not only outside the range 111, but also outside a predetermined range 112. That is, even if user A opens the door 32, user B will not be hit by the door 32. In this case, the results of both steps S13 and S17 are NO, and the controller 101 proceeds to step S16 and makes the unlocking operation effective. That is, after the unlocking operation is performed, it is made effective immediately. User A can thus open the door 32 without any delay.

### Specific Example 2

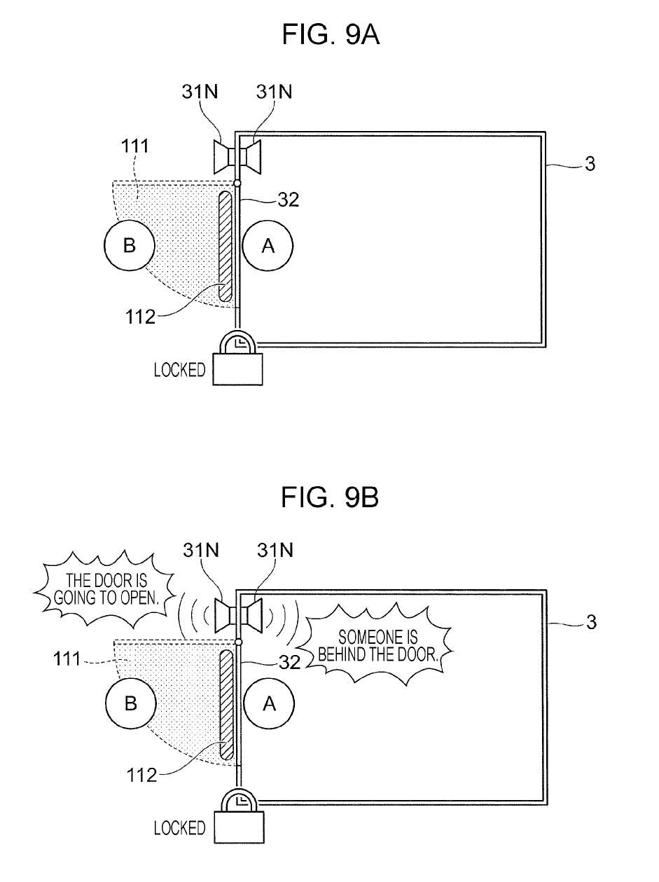

FIGS. 9A and 9B illustrate another example of the control operation when someone opens an outward-opening-type door 32 from indoors. FIG. 9A shows a state in which user B is located within the range 111 in which the door 32 moves to open. FIG. 9B shows the control operation.

In the example in FIGS. 9A and 9B, user B is positioned within the range 111. That is, if user A opens the door 32, user B may be hit by the door 32. In this case, the result of step S13 is YES, and the controller 101 executes steps S14 and S15. For example, the controller 101 informs user A that “Someone is behind the door.” to attract its attention, and informs user B behind the door 32 that “The door is going to open.” to instruct user B to move away from the door 32.

The information is provided before the unlocking operation is made effective. This allows user A and user B to pay attention to each other before the door 32 starts to open. User A can open the door 32 with attention and user B can respond to the moving of the door 32.

### Specific Example 3

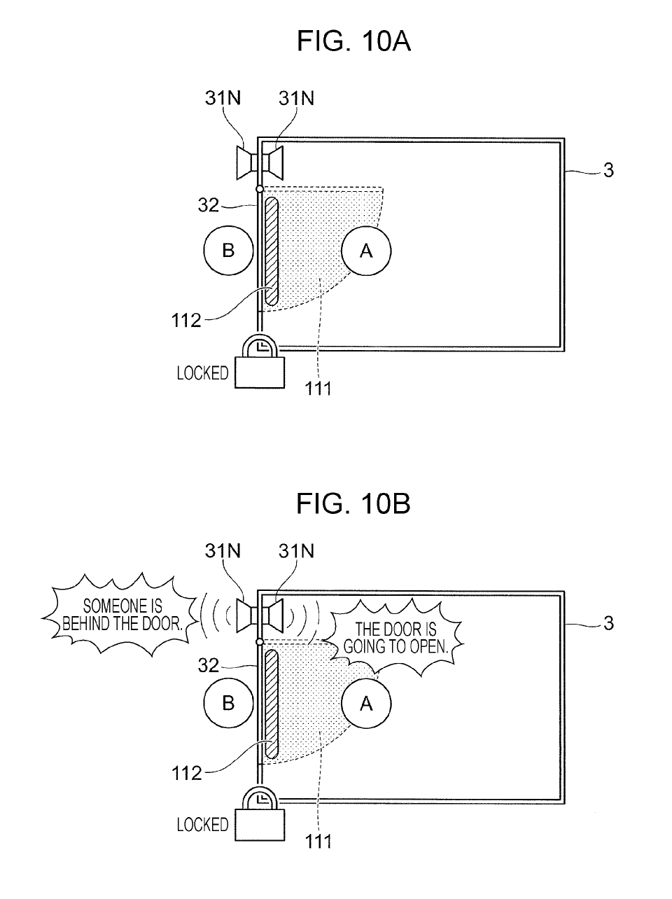

FIGS. 10A and 10B illustrate an example of the control operation when someone opens an inward-opening-type door 32 from outdoors. FIG. 10A shows a state in which user A is located within the range 111 in which the door 32 moves to open. FIG. 10B shows the control operation.

In the example in FIGS. 10A and 10B, user A is positioned within the range 111. That is, if user B opens the door 32, user A may be hit by the door 32. In this case, the result of step S13 is YES, and the controller 101 executes steps S14 and S15. For example, the controller 101 informs user B that “Someone is behind the door.” to attract its attention, and informs user A behind the door 32 that “The door is going to open.” to instruct user A to move away from the door 32.

The information is provided before the unlocking operation is made effective. This allows user A and user B to pay attention to each other before the door 32 starts to open. User B can open the door 32 with attention and user A can respond to the moving of the door 32.

### Specific Example 4

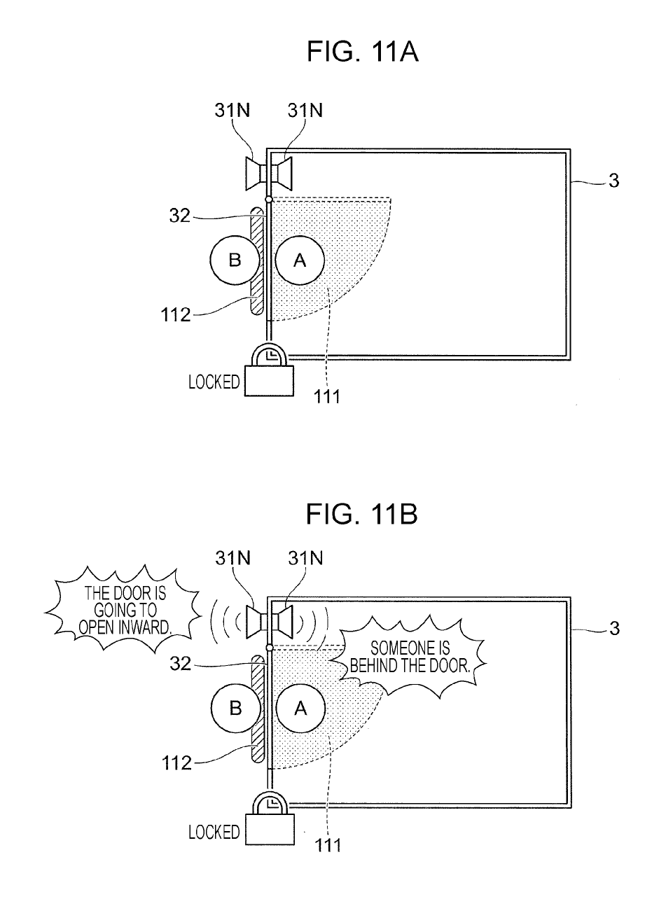

FIGS. 11A and 11B illustrate an example of the control operation when someone opens an inward-opening-type door 32 from indoors. FIG. 11A shows a state in which user B is located within the predetermined range 112 on the opposite side of user A. FIG. 11B shows the content of the control operation.

In the example in FIGS. 11A and 11B, user A is positioned within the range 111 in which the door 32 moves to open. However, the person within the range 111 is user A having performed the unlocking operation. In this case, the result of step S13 is NO.

Then, in step S17, the controller 101 judges whether someone is positioned within the predetermined range 112 behind the door 32 (that is, outdoors). In the example in FIGS. 11A and 11B, user B is positioned within the range 112 outdoors. In this case, the result of step S17 is YES, and the controller 101 executes steps S14 and S15. For example, the controller 101 informs user A that “Someone is behind the door.” to attract its attention, and informs user B behind the door 32 that “The door is going to open inward.” to instruct user B to move away from the door 32.

The information is provided before the unlocking operation is made effective. Even if user B leans against the door 32, it can stop leaning and move away from the door 32 before the door 32 starts to move. Even if the door 32 is unexpectedly flung open, user A will not be hit by the door 32 nor will user B lose its balance.

### Specific Example 5

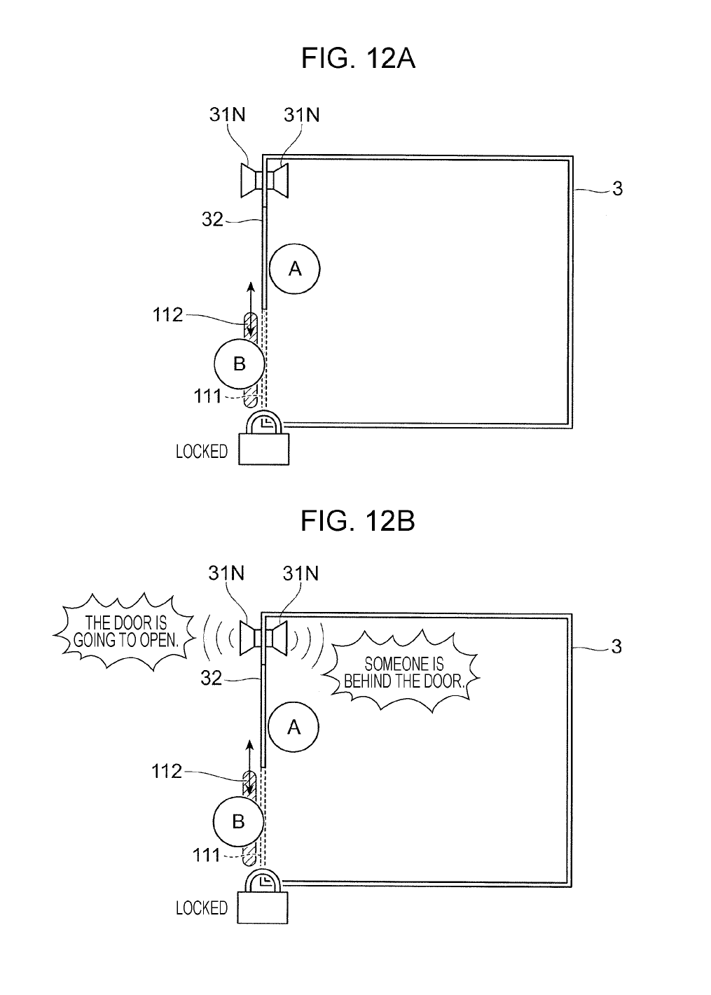

FIGS. 12A and 12B illustrate an example of the control operation when someone opens a sliding door 32. FIG. 12A shows a state in which user B is located within the range 111 in which the door 32 moves to open. FIG. 12B shows the control operation.

In the example in FIGS. 12A and 12B, user B is positioned within the range 111. That is, if user A opens the door 32, user B may be hit by the door 32. In this case, the result of step S13 is YES, and the controller 101 executes steps S14 and S15. For example, the controller 101 informs user A that “Someone is behind the door.” to attract its attention, and informs user B behind the door 32 that “The door is going to open.” to instruct user B to move away from the door 32.

The information is provided before the unlocking operation is made effective. This allows user A and user B to pay attention to each other before the door 32 starts to open. User A can open the door 32 with attention and user B can respond to the moving of the door 32.

### Second Example

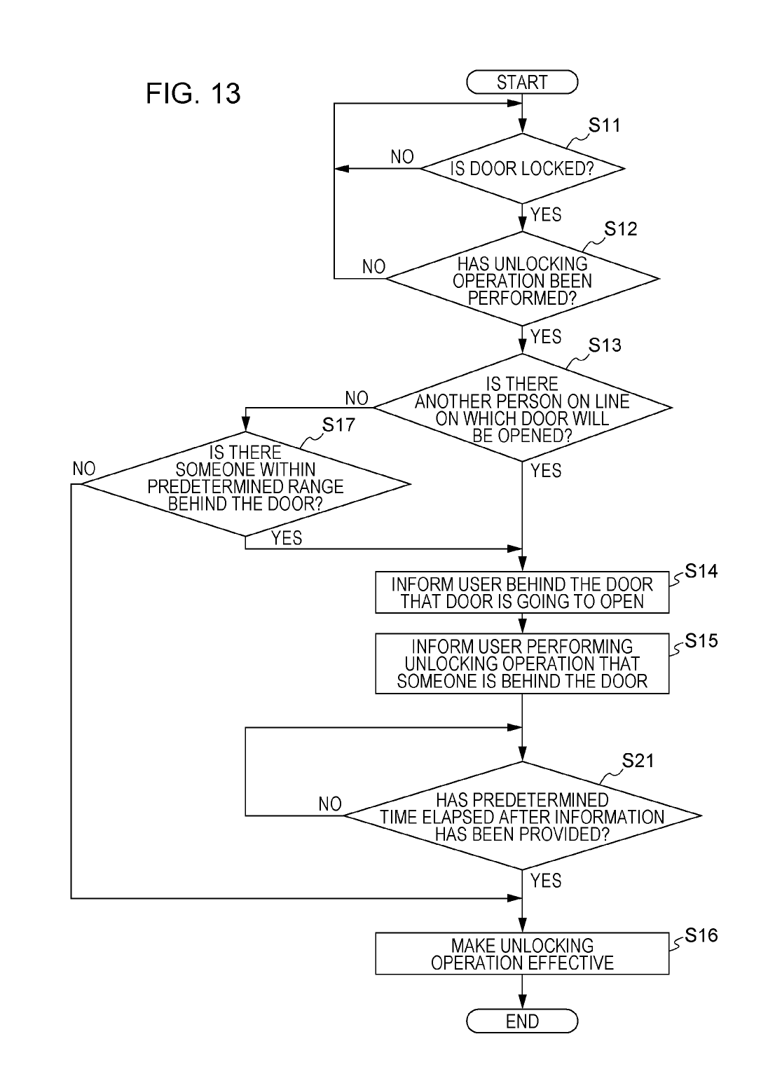

A second example of the control operation executed by the controller 101 will be discussed below with reference to FIG. 13.

FIG. 13 is a flowchart illustrating an example of the control operation executed by the controller 101 according to the second example. In FIG. 13, steps corresponding to those shown in FIG. 7 are designated by like step numbers.

The second example is different from the first example in that step S21 is inserted between steps S15 and S16 to judge whether a predetermined time has elapsed after the information has been provided to users.

Until the predetermined time has elapsed, the result of step S21 becomes NO, that is, step S21 is repeated. It is thus possible to secure the predetermined time, for example, ten seconds, before step S21 becomes YES and the unlocking operation is made effective.

In the above-described first example, although a warning is given before the door 32 is opened, if the unlocking operation is made effective immediately, the door 32 may open almost at the same time with the provision of a warning. This makes the informing function less effective.

In the second example, however, after the unlocking operation is performed, the predetermined time is given before this operation is made effective. This allows a user to have some time after being aware of the presence of someone behind the door 32 and before the door 32 starts to open. The user may also be able to make various preparations by using this time.

### Third Example

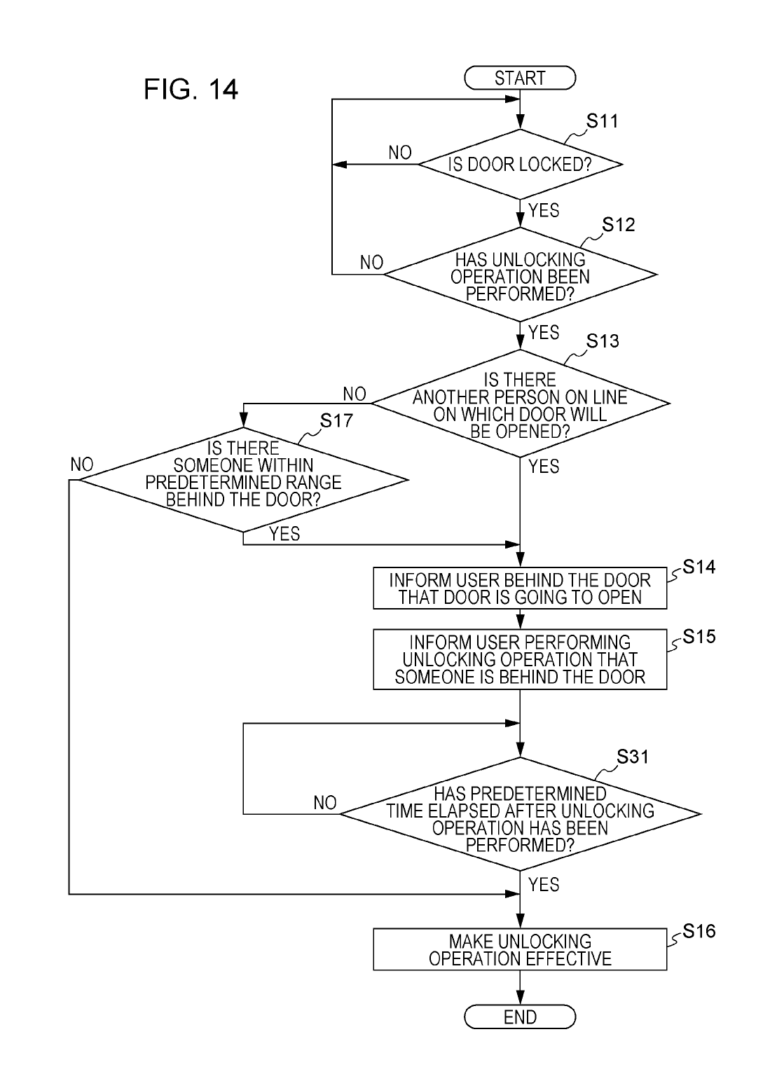

A third example of the control operation executed by the controller 101 will be discussed below with reference to FIG. 14.

FIG. 14 is a flowchart illustrating an example of the control operation executed by the controller 101 according to the third example. In FIG. 14, steps corresponding to those shown in FIG. 13 are designated by like step numbers.

In the third example, instead of step S21, step S31 is provided to judge whether a predetermined time has elapsed after the unlocking operation has been performed.

The difference between step S21 in FIG. 13 and step S31 in FIG. 14 is in the start point at which the predetermined time starts to count.

In the control operation of the third example, although the time from when the unlocking operation is performed until when the information is provided is variable, the time from when the unlocking operation is performed until when it is made effective is fixed.

### Fourth Example

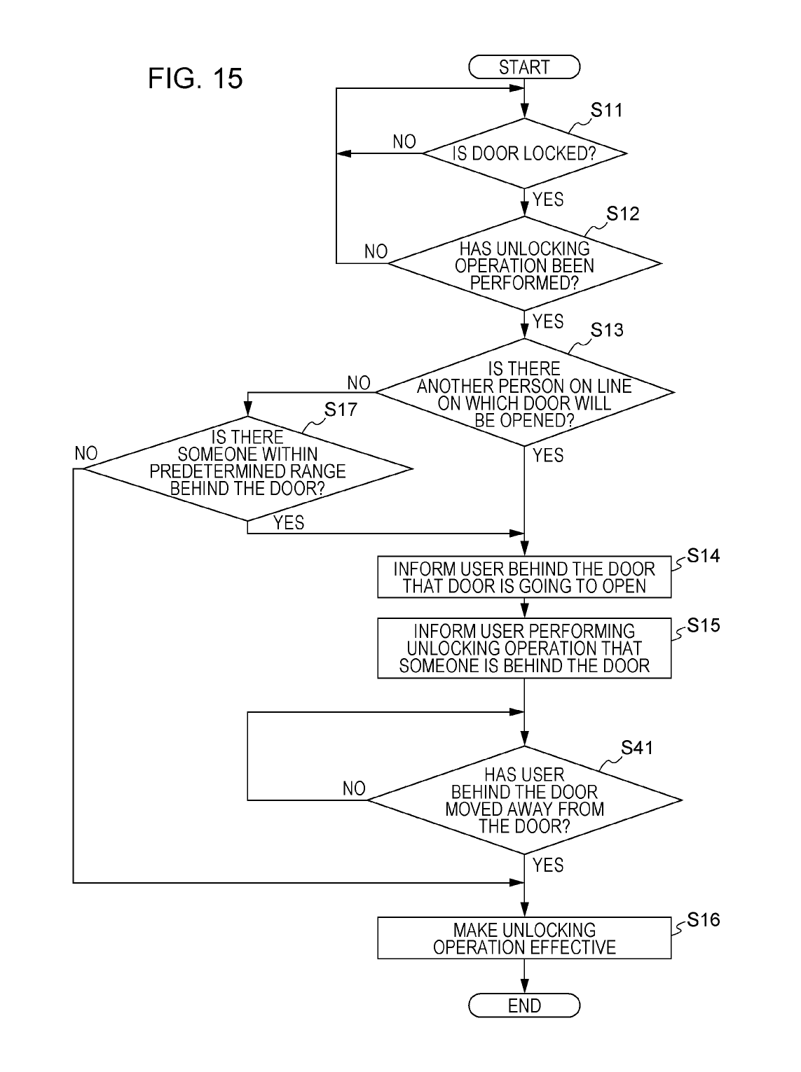

A fourth example of the control operation executed by the controller 101 will be discussed below with reference to FIG. 15.

FIG. 15 is a flowchart illustrating an example of the control operation executed by the controller 101 according to the fourth example. In FIG. 15, steps corresponding to those shown in FIG. 7 are designated by like step numbers.

The fourth example is different from the first example in that step S41 is inserted between steps S15 and S16 to judge whether a user behind the door 32 has moved away from the door 32. More specifically, in step S41, the controller 101 determines whether a person located within the range 111 has moved to the outside the range 111 or a person positioned within the predetermined range 112 has moved to the outside the predetermined range 112. This can be determined by using the human sensor 31B or the monitor camera 31L, for example.

In the first through third examples, even though information about the opening of the door 32 is provided, it depends on a person whether to actually move away from the door 32. Accordingly, when the door 32 is opened, it is still possible that a person will be hit by the door 32. In the fourth example, the unlocking operation is not made effective and the door 32 is not opened until the safety of a person behind the door 32 is checked.

### Fifth Example

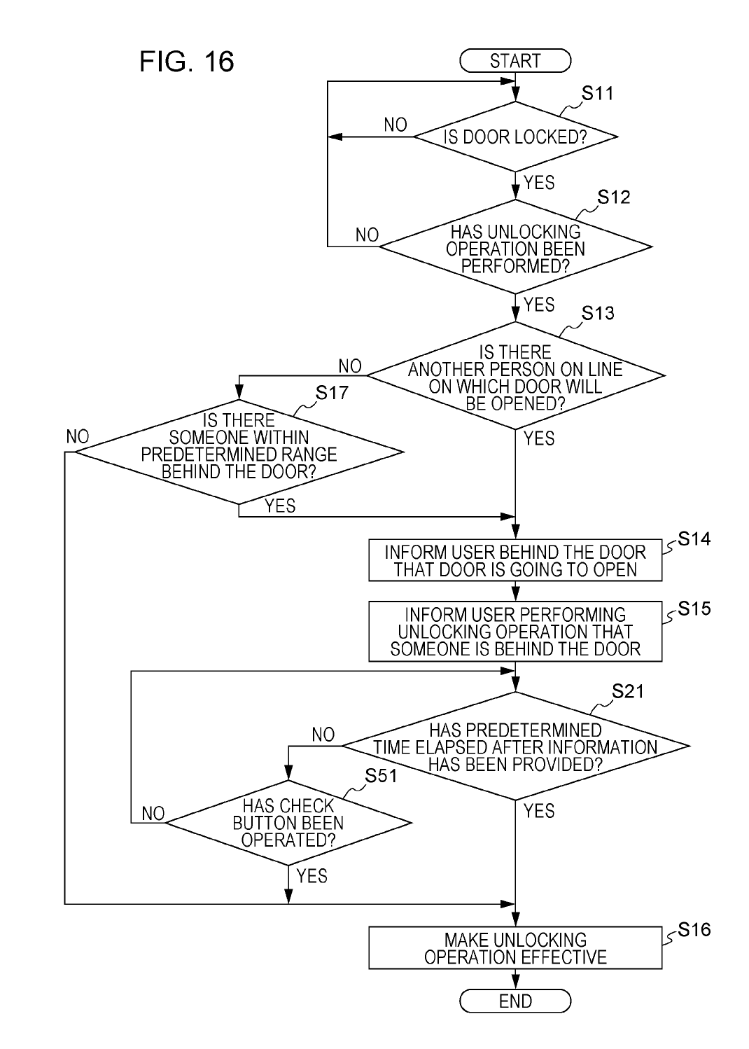

A fifth example of the control operation executed by the controller 101 will be discussed below with reference to FIG. 16.

FIG. 16 is a flowchart illustrating an example of the control operation executed by the controller 101 according to the fifth example. In FIG. 16, steps corresponding to those shown in FIG. 13 are designated by like step numbers.

In the above-described second example, the predetermined time is provided after the information is given to a user before the unlocking operation is made effective (step S21). If this time is too short, it is still possible that the user will be hit by the door 32. Hence, a long time may be set as the predetermined time.

However, if the user is ready, it does not have to wait for the predetermined time to elapse.

In the fifth example, if it is found in step S21 that the predetermined time has not elapsed yet (NO in step S21), the controller 101 judges in step S51 whether the user has checked the information provided in step S14. More specifically, the controller 101 judges in step S51 whether the user has operated a check button (not shown). If the result of step S51 is YES, the controller 101 can proceed to step S16 even before the predetermined time elapses. Operating of the check button is an example of a specific operation.

If the result of step S51 is NO, the controller 101 returns to step S21.

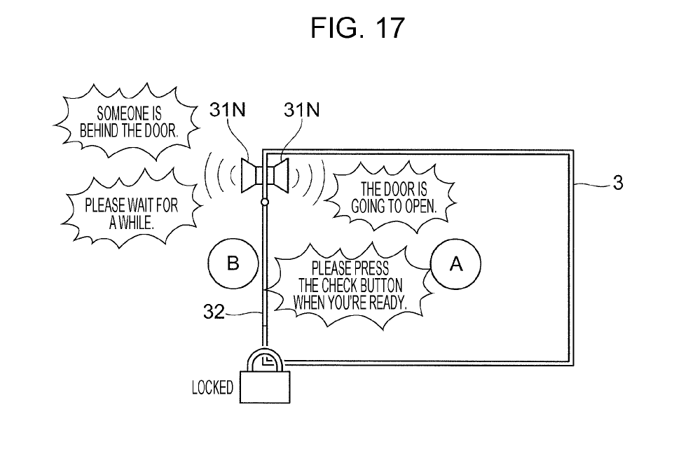

FIG. 17 illustrates a specific example of the control operation in the fifth example. In specific example 3 of the first example, only a warning is provided, as shown in FIG. 10B. In the fifth example, as shown in FIG. 17, not only a warning “The door is going to open.”, but also an instruction “Please press the check button when you're ready.” is provided to user A. For user B performing the unlocking operation, not only a warning “Someone is behind the door.”, but also an instruction “Please wait for a while.” is provided.

In the fifth example, it is possible to secure the predetermined time to let user B wait and user A behind the door 32 get ready.

The fifth example may be modified such that the unlocking operation is not made effective until the user operates the check button. In this setting, however, the door 32 may never be unlocked unless the check button is operated. Certain measures may desirably be taken for such a case.

A button for extending the time before the unlocking operation is made effective may be provided. If the user finds it hard to get ready before the unlocking operation is made effective, it operates this button to extend the time. The user may be able to extend the time every time it operates the button. Alternatively, the user may be allowed to extend the time only a limited number of times. The user may be able to select the extendable time from several options since the time required to get ready varies depending on the user.

### Sixth Example

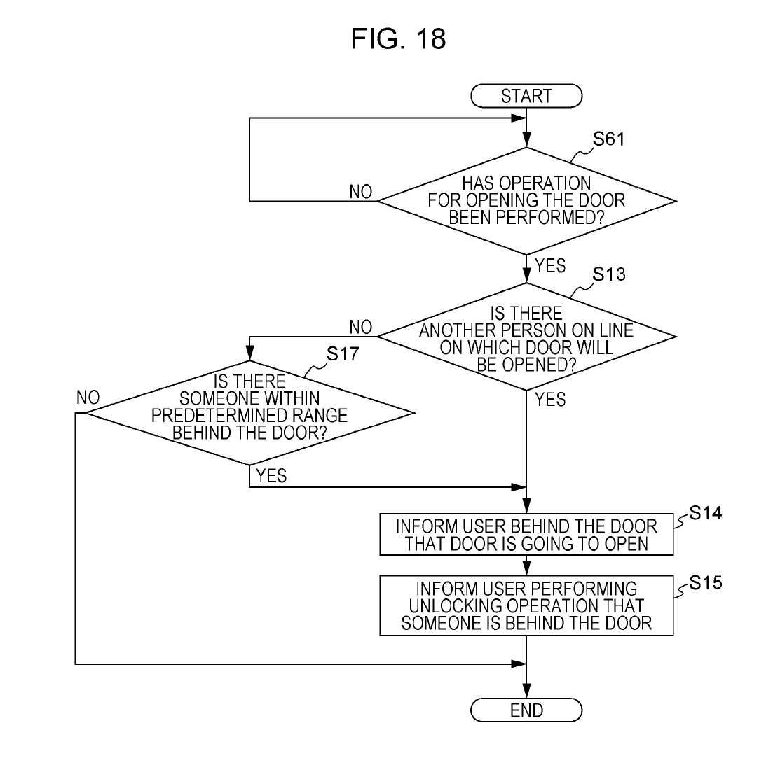

A sixth example of the control operation executed by the controller 101 will be discussed below with reference to FIG. 18.

FIG. 18 is a flowchart illustrating an example of the control operation executed by the controller 101 according to the sixth example. In FIG. 18, steps corresponding to those shown in FIG. 7 are designated by like step numbers.

The sixth example may be employed when the door 32 (see FIG. 2) does not have a locking function or when the door 32 is already unlocked.

In the sixth example, the controller 101 judges in step S61 whether an operation for opening the door 32 has been performed.

The operation for opening the door 32 is an example of an operation to set a door in a state in which the door will be opened. The operation for opening the door 32 may include a certain action suggesting that the operation for opening the door 32 will be performed, such as a gesture of extending a hand to the handle of the door 32 or touching the handle. The controller 101 may use imaging data output from the monitor camera 31L, for example, to judge whether the operation for opening the door 32 has been performed.

While the result of step S61 is NO, the controller 101 repeats step S61. If the operation for opening the door 32 has not been performed, nobody enters or leaves a space 3. This judgement is made regardless of whether a user is indoors. The operation for opening the door 32 may be performed either from indoors or from outdoors.

If the result of step S61 is YES, the controller 101 judges in step S13 whether another person is located on a line on which the door 32 moves to open. If the result of step S13 is YES, the controller 101 executes steps S14 and S15 and completes the processing. The user indoors and that outdoors are aware of the other person behind the door 32 and are prepared for the opening of the door 32.

If the result of step S13 is NO, the controller 101 executes step S17, as in the first example. If the result of step S17 is YES, the controller 101 executes steps S14 and S15 and completes the processing. If the result of step S17 is NO, the door 32 can be opened without any attention, and the controller 101 terminates the processing. In this case, the user having performed the operation for opening the door 32 can enter and leave the space 3 without any attention.

### Seventh Example

In the above-described first through sixth examples, before the door 32 is opened, information about the presence of someone is provided to a person on one side of the door 32 and information about the opening of the door 32 is provided to a person on the other side of the door 32 to instruct them to pay attention to each other.

In a seventh example, in addition to the above-described information by sound or text, information indicating the range 111 in which the door 32 moves to open or the outer edge of the range 111 is provided.

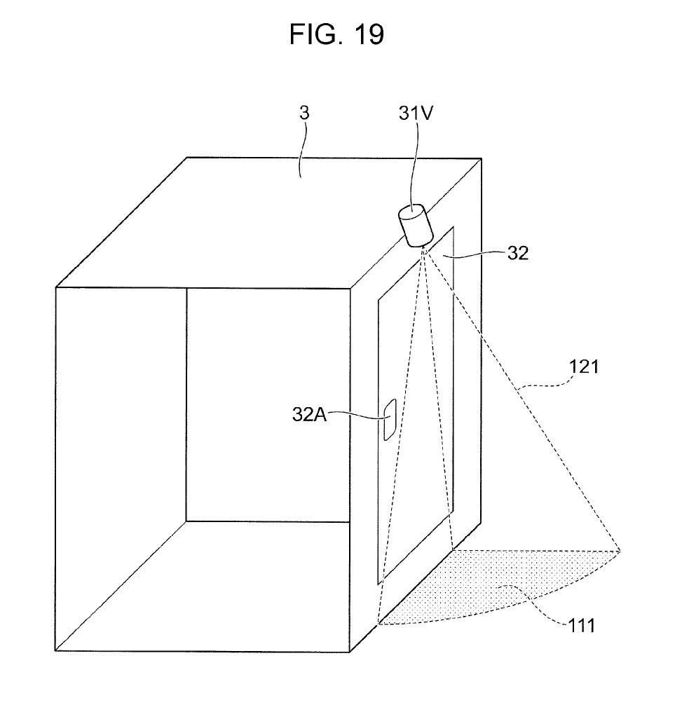

FIG. 19 illustrates an example in which an outward-opening-type door 32 is fixed to a space 3 and the range 111 is indicated by illumination light 121. In this example, the light source 31V emitting the illumination light 121 is fixed to the top side of the space 3. However, the light source 31V may be fixed to any position of the space 3. For example, the light source 31V may be fixed to a wall of a place where the space 3 is disposed. If the door 32 is an inward-opening type, the light source 31V is fixed indoors.

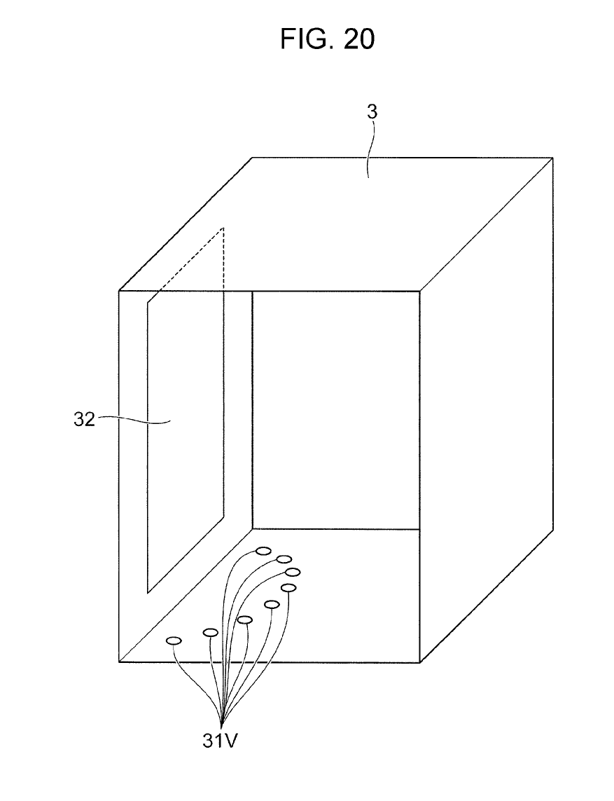

FIG. 20 illustrates an example in which an inward-opening-type door 32 is fixed to a space 3 and plural light sources 31V are disposed along the outer edge of the range 111 in which the door 32 moves to open. In this example, the light sources 31V are embedded in the floor 30B (see FIG. 2) of the space 3. If the door 32 is an outward-opening type, the light sources 31V may be embedded along the outer edge of the range 111 in the floor of a place where the space 3 is disposed.

With the configuration of the seventh example, a user on the side toward which the door 32 opens can visually check the range 111 of the moving door 32 or its outer edge to identify at which position the user has to be moved.

### Eighth Example

In the above-described first through seventh examples, information about the presence of someone is provided to a person on one side of the door 32 and information about the opening of the door 32 is provided to a person on the other side of the door 32 in advance to instruct them to pay attention to each other. However, even when such information is provided in advance, if the door 32 is flung open, a person positioned within the range 111 may not have time to move away from the door 32 and be hit by the door 32.

In the eighth example, the magnitude of a load acting on the door 32 is controlled or the drive speed of the door 32 is decreased so that the speed of the door 32 that has started to open will be lower than a predetermined speed.

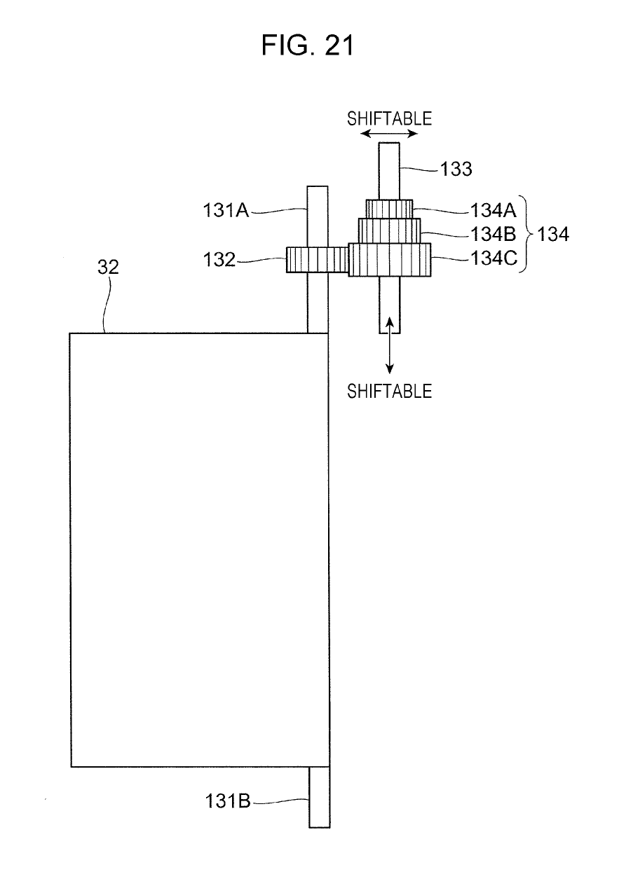

FIG. 21 illustrates an example of a mechanism for decreasing the speed of a hinged door 32 that has started to open. The door 32 is pivotably fixed to a housing by a pivot shaft 131A on the upper side (ceiling side) and a pivot shaft 131B on the lower side (floor side). In the example in FIG. 21, a door gear 132 is coaxially fixed to the pivot shaft 131A.

A transmission gear 134 is constituted by three gears 134A, 134B, and 134C fixed to a pivot shaft 133. The dimensions of the three gears 134A, 134B, and 134C are different from each other. The gear 134B is larger than the gear 134A, and the gear 134C is larger than the gear 134B. Although in FIG. 21 the transmission gear 134 is constituted by the three gears 134A, 134B, and 134C, it may be constituted by less than or more than three gears. Another type of transmission gear may alternatively be used.

The position of the transmission gear 134 with respect to the door gear 132 is shifted. For example, when the door 32 has just started to move, the transmission gear 134 is adjusted to be at a position (gear dimension 1) at which the gear 134A and the door gear 132 are engaged with each other. When the opening angle of the door 32 becomes greater, the transmission gear 134 is adjusted to be at a position (gear dimension 2) at which the gear 134B and the door gear 132 are engaged with each other. When the opening angle of the door 32 exceeds a predetermined angle, the transmission gear 134 is adjusted to be at a position (gear dimension 3) at which the gear 134C and the door gear 132 are engaged with each other.

In FIG. 21, the shifting of the transmission gear 134 is indicated by the two double-headed arrows. One double-headed arrow indicates the shifting of the transmission gear 134 in the axial direction of the pivot shaft 133. The other double-headed arrow indicates the planar shifting of the transmission gear 134 in a direction perpendicular to the pivot shaft 133. The pivot shaft 133 is shifted by a drive mechanism, which is not shown.

Shifting of the pivot shaft 133 is controlled by the controller 101.

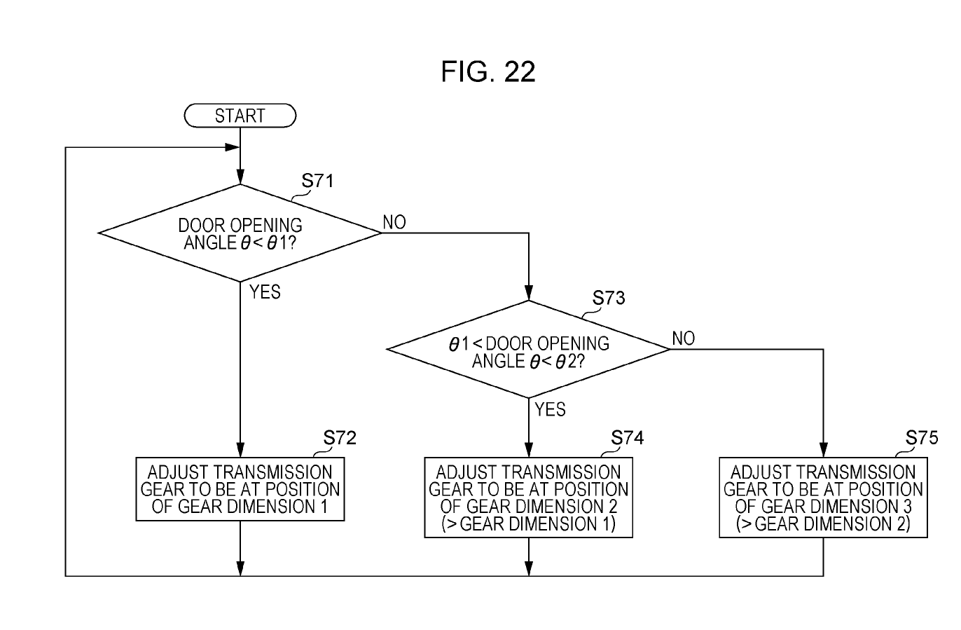

FIG. 22 is a flowchart illustrating an example of the speed control operation to be performed when a hinged door 32 is opened. The opening angle of the door 32 is zero when the door 32 is closed and is increased in the direction in which the door 32 is opened.

In step S71, the controller 101 first compares the opening angle θ of the door 32 with a first reference angle 81. If the opening angle θ of the door 32 is smaller than the reference angle θ1 (YES in step S71), the controller 101 adjusts the transmission gear 134 to be at the position of gear dimension 1 in step S72.

If the opening angle θ of the door 32 is equal to or greater than the reference angle θ1 (NO in step S71), the controller 101 compares the opening angle θ of the door 32 with a second reference angle θ2 in step S73. If the opening angle θ of the door 32 is smaller than the reference angle θ2 (YES in step S73), the controller 101 adjusts the transmission gear 134 to be at the position of gear dimension 2 in step S74.

If the opening angle θ of the door 32 is equal to or greater than the reference angle θ2 (NO in step S73), the controller 101 adjusts the transmission gear 134 to be at the position of gear dimension 3 in step S75.

Under the shifting control of the transmission gear 134, when the door 32 opens manually, the magnitude of a load acting on the door 32 that has started to open can be increased so that the door 32 will not open fast. If the door 32 opens slowly, a user has time to move away from the door 32.

When the door 32 is opened under electrical control, the pivoting speed of the door 32 that has started to open can be decreased to be lower than that when the opening angle of the door 32 becomes greater if the speed for pivoting the pivot shaft 133 is constant. Under this control, a user has time to move away from the door 32.

In the case of a sliding door 32, the magnitude of a load acting on the door 32 is set to be changeable, not according to the angle, but according to the distance by which the door 32 moves to open. When a sliding door 32 is opened under electrical control, the speed of the door 32 that is started to move is controlled so that it can be decreased.

### Other Exemplary Embodiments

The exemplary embodiment of the invention has been discussed above. However, the technical scope of the invention is not restricted to the exemplary embodiment. Various modifications and/or improvements may be made, and exemplary embodiments based on such modifications and improvements are also encompassed within the technical scope of the invention.

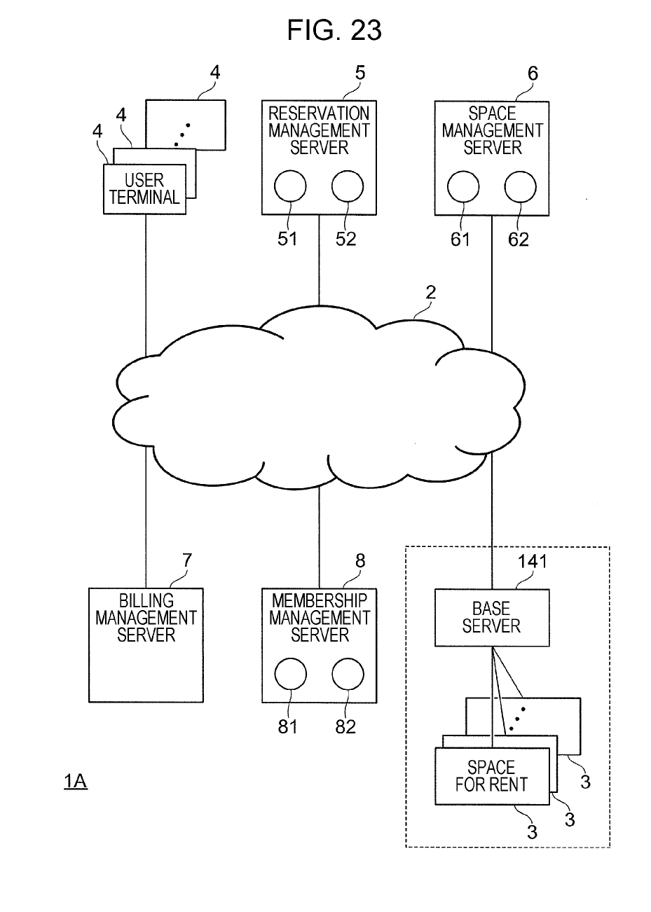

The management system 1 (see FIG. 1) is not restricted to the above-described configuration. FIG. 23 schematically illustrates another example of the configuration of the management system 1, that is, the configuration of a management system 1A. In FIG. 23, elements corresponding to those in FIG. 1 are designated by like reference numerals. The management system 1A is different from the management system 1 in that a base server 141 is used for managing the plural spaces 3. The base server 141 configured as a computer may perform the functions of the controller 101 (see FIG. 6) by executing a program. In this sense, the base server 141 is an example of the apparatus.

In the above-described exemplary embodiment, a small room having a soundproof function, such as that shown in FIG. 2, is assumed as a space 3. However, meeting rooms, study rooms, and various types of guest rooms may be used as spaces 3 if reservations are required to be made for renting the spaces 3.

The above-described exemplary embodiment has been described, assuming that the door 32 can be locked. However, the above-described control function is still applicable when the door 32 is not possible to lock.

In the above-described exemplary embodiment, the spaces 3 are rented on a time basis. However, the spaces 3 may be rented based on another factor.

In the above-described exemplary embodiment, the subject that opens or unlocks the door 32 fixed to a space 3 and the object located on a path of the moving door 32 are both natural persons. However, one of the subject and the object may be an animal or a robot. In this sense, each of a natural person, an animal, and a robot is an example of an existing subject.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An apparatus comprising:
a controller that causes, when an operation to set a door in a state in which the door will be opened is performed by a first existing subject and if a second existing subject is located on a path on which the door moves to open, an informing unit to provide information that the door will be opened and the second existing subject is on the path.

2. The apparatus according to claim 1, wherein the operation is an unlocking operation.

3. The apparatus according to claim 2, wherein the unlocking operation is made effective if a predetermined condition is satisfied.

4. The apparatus according to claim 3, wherein the predetermined condition is a condition that the controller causes the informing unit to provide the information.

5. The apparatus according to claim 3, wherein the predetermined condition is a condition that a predetermined time elapses after the controller has caused the informing unit to provide the information.

6. The apparatus according to claim 3, wherein the predetermined condition is a condition that a predetermined time elapses after the unlocking operation has been performed.

7. The apparatus according to claim 3, wherein the predetermined condition is a condition that the second existing subject moves to a position which does not cross the path.

8. The apparatus according to claim 3, wherein the predetermined condition is a condition that the second existing subject performs a specific operation in response to the information provided by the informing unit.

9. The apparatus according to claim 2, wherein the unlocking operation is made effective without any delay if the second existing subject is not detected on the path.

10. The apparatus according to claim 1, wherein the operation is an operation for opening the door.

11. The apparatus according to claim 1, wherein the controller provides information indicating a range in which the door moves to open.

12. The apparatus according to claim 11, wherein the controller indicates the range by using illumination light.

13. The apparatus according to claim 11, wherein the controller indicates an outer edge of the range.

14. The apparatus according to claim 1, wherein the controller causes the informing unit to provide at least part of the information to both inside a room and outside the room, the room being separated from the outside by the door.

15. The apparatus according to claim 1, wherein, if the door is an inward-opening type, when the operation is performed outside a room, the controller causes the informing unit to provide at least part of the information to inside the room, the room being separated from the outside by the door.

16. The apparatus according to claim 1, wherein, if the door is an inward-opening type, when the operation is performed outside a room, the controller causes the informing unit to provide at least part of the information to outside the room, the room being separated from the outside by the door.

17. The apparatus according to claim 1, wherein, if the door is an outward-opening type, when the operation is performed inside a room, the controller causes the informing unit to provide at least part of the information to outside the room, the room being separated from the outside by the door.

18. The apparatus according to claim 1, wherein, if the door is an outward-opening type, when the operation is performed inside a room, the controller causes the informing unit to provide at least part of the information to inside the room, the room being separated from the inside by the door.

19. The apparatus according to claim 1, wherein, if the second existing subject is not detected on the path, the controller does not cause the informing unit to provide the information.

20. The apparatus according to claim 1, wherein the controller performs control so that a speed of the door that has started to open will not exceed a predetermined speed.

21. The apparatus according to claim 1, wherein the door is fixed to a space to be rented.

22. A management system comprising:
a controller that causes, when an operation to set a door in a state in which the door will be opened is performed by a first existing subject and if a second existing subject is located on a path on which the door moves to open, an informing unit to provide information that the door will be opened and the second existing subject is on the path.

23. A non-transitory computer readable medium storing a program causing a computer to execute a process, the process comprising:
causing, when an operation to set a door in a state in which the door will be opened is performed by a first existing subject and if a second existing subject is located on a path on which the door moves to open, an informing unit to provide information that the door will be opened and the second existing subject is on the path.
